(19) United States
(12) Patent Application Publication
(10) Pub. No.: US 2017/0182463 A1
(43) Pub. Date: Jun. 29, 2017

(54) FILTER PLATE ASSEMBLY

(71) Applicant: SANI MEMBRANES APS, Værløse (DK)

(72) Inventor: Henrik HJELMSMARK, Værløse (DK)

(73) Assignee: SANI MEMBRANES APS, Værløse (DK)

(21) Appl. No.: 15/115,593

(22) PCT Filed: Feb. 2, 2015
(86) PCT No.: PCT/EP2015/052074

§ 371 Date: Jul. 29, 2016

(30) Foreign Application Priority Data
Feb. 3, 2014 (DK) PA 2014 70050

(51) Int. Cl. B01D 63/08; B01D 65/02; B01D 63/16

(52) U.S. Cl. CPC B01D 63/084; B01D 63/16; B01D 65/02; B01D 2313/14; B01D 2315/10

(57) ABSTRACT

A novel embodiment of a Free Flow Filtration Unit ensuring unimpeded flow of media to be filtered and unimpeded flow of permeated media in a leakage proof fully fused rigid unit. A Filtration Unit fused into a singular element, formed by a fused stack of internally channeled flat filter plates (1) each plate formed by fusing of two molded flat half filter plates (2, 3), the filter effect formed by perforation slits or holes (10) in the surface of the plates, said perforations connecting to channels (9) in the plates for free flow of permeate (filtered media) leading to one or more exit (4) perpendicular to the plate, the filter plate exits forming exit channels for permeate from the Filtration Unit as the filter plates (1) are fused into a stack at the exit (4) and at bonding points (8) securing that the filter plates are spaced and rigidly fixed at specific distance in the stack, offering slit like gaps at least at 2 sides for free access and exit flow of media to be filtered. The filter area surface (6) can be covered by fusing a fine filter (7), typically an organic flat sheet membrane, to the filter area surface, whereby very fine micro or ultra-filtration or even molecular filtration can be achieved.

The present invention relates to a filter plate assembly configured for cross-flow filtration, said filter plate assembly comprises a plurality of planar filter plates and one or more permeate exits, said filter plates comprises a first and a second rigid surface, said surfaces comprise perforations, said surfaces enclosing a volume, said perforations are fluidly connected to said one or more permeate exits through said volume.

### FIELD OF THE INVENTION

The invention relates to fine filtration or microfiltration, ultrafiltration and to molecular (Nano and RO) filtration using membranes typically subjected to a tangential flow, and especially to providing a robust and sanitary assembly of filter plates capable of being configured to filtering from 500 micron down to micro filtration, ultra filtration or reverse osmotic separation.

The media to be filtered can pass freely between the filter plates so that free flow filtration is obtained and the media to be filtered can be highly viscous and even contain larger particulate impurities, as long as the media do not blockage the free flow passage between plates. The term permeate is used for the media that has passed through the filter and the term retentate relates the media to be filtered.

The term fine filtration applies to filtration through slits or holes in the filter plates of 50 to 500 microns whereas microfiltration usually apply to particle sizes between a few hundredths of micrometers and to tens of micrometers and carried out at low differential pressure from just above zero to a few bars. Fine filtration is often used as safety filter for process equipment. Micro filtration is as example used for sterile filtration of milk. Ultrafiltration is used for example for separating large organic molecules from mineral molecules or small organic molecules and a higher differential pressure of 1-15 bars may be needed. Nano and Reverse Osmoses separate even smaller molecules and higher differential pressures are needed.

When filters are used in a cross flow configuration, the media to be filtered is pumped at speed of typically 2 to 5 meter per second across the surface of the filter to keep solids from building up and depositing on the filter and to keep a small as possible boundary layer above the filter surface, hereby keeping the filter openings free and functional for a longer time in operation.

The term permeate is used for the media that has passed through the filter and the term retentate relates the media to be filtered.

### DESCRIPTION OF THE PRIOR ART

The efficiency of the filter surface in form of flux per square meter or amount of produced permeate per square meter in the commonly known and used filters is often not very high, as optimal flux is only obtained in a hydrodynamic homogeneous configuration. The known filters in most configurations are designed with a large pressure gradients in the media to be filtered, and often even with a nonhomogeneous and high pressure loss also in the permeate flow. At the same time filtration is hampered by concentration polarization of media close to the filter surface.

The large pressure difference in the flowing media is caused by a wish for a high packing density of filter area and a wish for high turbulence over the filter area at a low flow volume in order to keep a high flux of permeate by keeping the filter clean. As a way to achieve this, the free flow area above the membrane is minimized, for example with small diameter tubes or narrow gap in plate and frame solution or even obstructed with turbulence creating spacer netting between filter areas. These measurements leads to lowering capital plant cost for commercially available membrane filters at the cost of higher energy consumption.

Tubular membranes have free flow channels for media to be filtered of a few mm up to 25 mm and are bundled and placed in long tubular Filtration Units. The tubular filter channels provide excellent free passage for impurities, and they can be dimensioned to operate at low cross flow pressure loss. However tubular membranes are very costly, so normally a higher cross flow pressure loss is accepted to maximize flux of permeate per square meter membrane. The high cross flow speed and the large tubes leads to a very high energy consumption to drive the cross flow. Another aspect of tubular membranes is that they are often not resistant to high differential pressure over the membranes as the tubes are vulnerable to the internal pressure. Some tubular membrane units are capable of being back-flushed, but mostly this is not the case.

Free flow Plate type filtration modules are used as Submerged Assemblies, Plate and Frame units or In Channel variants.

Submerged assemblies are typically used for Membrane Bio Reactors and a number of prior designs are available, typically large flat sheet elements (TW200920471, US2013043189) with little focus on clean ability, as they anyway operate with waste water, or as guard filter for very clean water.

The Plate and Frame units are typically used for food, pharma or biopharma process industry applications and these units also have free flow filtration capability. As the plates are pressed together in a frame the units have lots of long joints, prone to leakage. A variant of prior art is the Fluid Separating Apparatus mentioned in GB1381681, where membrane is glued into a channeled plate assembly in a plate-and-frame squeeze type unit. These Plate and Frame Filtration Units also have a very high square meter price as they are very complicated and highly technical units.

The In Channel Plate units such as the flat filtering elements described in U.S. Pat. No. 4,816,150, JP20088183561, or in U.S. Pat. No. 5,626,752, describing flat membrane cushions or pads are so far formed as a complex assembly of individual components—membrane cushions or flat sheet membranes pressed or pinched together in various ways whereby permeate exits are separated from media to be filtered with some type of gasket or sealing effect, either created by a squeezed or pinched gasket or the membranes functioning as gasket. As the Plate and Frame units, some of these exhibits have free flow filtration capability, but are vulnerable to leakage. A built up type of plate filter unit such as JPS59062323 is based on round, disc shaped plates, built up of two half plates that are not edgewise supported with one central exit for permeate, hence limiting size of free plate area and direction of flow of media to be filtered.

### DESCRIPTION OF INVENTION

It is an object of the present invention to provide a filter plate assembly having a simple construction with optimized free flow filter capacity and low pressure loss of media involved.

This is achieved by a filter plate assembly where said filter plates comprises a protrusion, said protrusions of said plurality of filter plates combined forms said permeate exits from the filter plate assembly.

Hereby a simple construction is obtained by use of a limited number of components. Thus, the design of the invention allows avoiding use of glues and questionable substances and allows for use of reusable plastics so that the unit as a whole can be re-circulated for reuse.

In an embodiment, one or more of said filter plates comprises two half filter plates, said half filter plates are bonded at the periphery of the filter plates. Hereby the invention is without gaskets or other squeezed seals providing a leakage free plate and frame type design, but without frame, and still rigid enough to withstand operation and the differential pressure between media and permeate flows.

In an embodiment, said half filter plates being identical in shape.

In an embodiment, said one or more permeate exits extends perpendicular to the plane defined by the extent of said filter plates. A compact construction of a filter plate assembly is obtainable and a non-impeding drainage of an assembly of plates is possible.

In an embodiment, said filter plates comprises an additional filter sheet positioned and bonded adjacent to said perforated surface of said filter plates. Hereby, the filter plate assembly may comprise two layers of filters with different properties, and said bonding may allow for back wash cleaning of the filter area.

In an embodiment, said filter plates comprises bonding points for bonding two adjacent filter plates, said bonding points together with the protruding permeate exits defining the distance between two filter plates and constructing a rigid and robust assembly able to withstand the process and a defined spacing between filter plates allowing for a free and unimpeded flow of media to be filtered. The free and unimpeded flow of media to be filtered allows for filtration of very viscous media, as the length of the filter and thus flow path is relatively short and at the same time distance between filter plates can be selected optimally to the process.

In an embodiment, said filter plate assembly comprises a plurality of filter plates and a housing, said filter plates are situated parallel juxtaposed having the perforated surface facing the perforated surface of an adjacent filter plate, said housing encompass said plurality of filter plates forming a square or rectangular entry for a media (A) to be filtered and a retentate exit (B). The free gaps between filter plates allow for inspection of all media touched areas of the filter making visual inspection of cleaning and process possible through a see through glass in said housing.

In an embodiment, said filter plate assembly comprising actuation means for mechanical actuation of said filter plate assembly in a plane parallel to the extent of said filter plates (1). The movement of the filter plate assembly keeps the filter surface clean and secures lower concentration gradient of media close to the filter surface. Thereby increasing flux of permeate per square meter filter area and keep the filter operational for longer time.

In an embodiment, said housing comprises through hole for permeate exits (4,5) extending perpendicular to said media entry (A) and retentate exit (B). Hereby is obtained a simple and compact construction separating the media to be filtered (A) and the permeate (C,D).

An embodiment of a Free Flow Filtration Unit ensuring unimpeded flow of media to be filtered and unimpeded flow of permeated media in form of a leakage proof fully fused rigid element.

The Filtration Unit formed by a rigidly fused stack of internally channeled rigid flat filter plates (1) each plate formed by fusing of two molded flat half filter plates (2, 3), the filter effect formed by perforation slits or holes (10) in the surface of the plates, said perforations connecting to the channels (9) in the plates, where the two half plates meet, said internal channels allowing a free flow of permeate (filtered media) leading to one or more exits (4, 5) perpendicular to the plate.

The filter plate exits form exit channels for permeate from the fused Filtration Unit as the filter plates (1) are fused into a stack at the exits (4, 5) and at bonding points (8) securing that the filter plates are spaced and rigidly fixed at specific distance in the stack, offering slit like gaps at least at 2 sides for free access and exit flow of media to be filtered.

The filter plates are stacked with spacing for of media to be filtered, offering free flow in between filter areas through slit like gap for access and flow of media to be filtered. The filter plates are fused together from a few plates, to many dozens of plates in one fused rigid Filtration Unit and in operation the Filtration Unit is placed in a suitable flow for media to be filtered.

The filter area surface (6) can be covered by fusing a fine filter (7), typically an organic flat sheet membrane, to the filter surface, securing an edge sealed fusing of the fine filter, whereby very fine micro or ultra-filtration or even molecular filtration can be achieved.

The fine filter can also be compounded directly on the filter plate, using the filter plate as perforated base for the fine filter. The fine filter can as an example be in the form of a phase inversion mold or a sintered fine filter layer on the filter plate.

The filter plates (1) are compounded by two half plates and these can be exact equals or of different design however with similar perforation and hence a uniform filtration function.

The amount of perforations is maximized in the filtration areas of the plate, however limited by possible density of connected channels or space for permeate, as the plate with permeate channels connecting to one or more exits must be rigid enough to withstand operation and so be designed to withstand the differential pressure between media and permeate flows. The internal channels (9) can be formed as tubular channels of any form or as a corrugated area that has free space for flow between contact points.

The invention provides then a singular, compounded, rigid Filtration Unit which has, with respect to known filtration and membrane Filtration Units, the advantages of having at the same time, a fully free flow thickness of the liquid stream to be filtered, defined by distance between filter plates (1 to 6 mm) and also by the flow channel, the filter plates being of limited thickness however rigid (3-6 mm thick, consisting of 2 fused half plates) making a compact composite unit possible, the Filtration Unit having a limited length of the path of the liquid to be filtered (10 to 100 cm) and a non-impeding similar short but relatively large area (up to about half of filter plate thickness) of channel for permeate draining leading channels for permeate discharge leading to one or more larger perpendicular exit channels (10-50 mm in diameter), sized to lead all the permeate from the Filtration Unit to the exit with negligible pressure loss, and an overall structure as a fused unit, having sufficient mechanical strength for it to keep a constant geometry, guaranteeing the stability of the hydrodynamic conditions, under pressure, mechanical actuation, media and temperature constraints, being without gaskets so with no risk of leakage and at a very satisfactory constructional cost.

The spacing between filter plates and the size of the filter area and the size of flow channel in which the Filtration Unit is placed, is then so balanced, that even with a high cross flow velocity to keep the filter area clean applied, little pressure loss is seen in the media to be filtered, and so a very optimal and homogeneous filtration configuration is achieved, leading to a high flux and low energy consumption.

The filtration area is formed by numerous slits or holes formed conically with smaller opening to outside and widening out towards the internal permeate channel, thereby securing that a minimal of blocking will take place in the permeate exit path. The slits or holes are dimensioned to needed degree of filtration, typically 50-500 micron.

Preferred perforation filter slits are 100-150 micron wide by 5 mm long, spaced 5 mm in between, ensuring sufficient area for permeate exit, while at the same time supporting the plate for differential pressure and maintaining a rigid plate function. When covered with membrane cloth, these filter slits ensure sufficient area for permeate exit and support the membrane for trans-membrane pressure.

The filter plates are spaced with a gap giving the thickness of the liquid stream, so that the media to be filtered can flow through with flow speed (typically 1-5 m/s) when operating in a cross flow mode or access freely to the filter area when operating in dead end mode or interrupted cross flow mode, the spacing adapted to media impurities, viscosity and acceptable pressure loss and the flow channel configured to guide the flow into the slits or gaps between filter plates in the Filtration Unit.

The entry for flow of liquid to be filtered is formed as slits created by the spacing, the gap, between adjoining plates of filter plates stacked into a compounded filtration unit. The “inlet” edge of the filter plates are hydro dynamically shaped with a gradient edge to reduce pressure loss at entry or exit of the filter area, this is especially relevant when the Filtration Unit is used for cross flow filtration.

The flow channel is configured to guide the flow into the Filtration Unit and at the same time designed to withstand the pressure needed for pressure between media and permeate and for cross flow pressure loss. The Flow channel have exits for permeate connected with the exits in the Filtration Unit.

The thickness of the liquid stream can be chosen to allow high speed gradients to be obtained for relatively low flow volumes. The plate surface at the filtration area can be corrugated to increase turbulence over the filter area, thereby in some situations, increasing flux of permeate through the filter. The thickness of the liquid stream to be filtered is decided by the height of the perpendicular exits from the filter plates and bonding points placed conveniently on the filter plates or on the sides of these outside the filtration area.

The limited length of the path of the filtered product avoids high concentration gradients in the flowing media and thus ensures a homogeneous process and pressure of the filtering and filtered product thorough out the Filtration Unit, this in term leading to possibility for a high yield in flux of permeate per square meter of filtration area and long operation time between cleanings. As the media flow concentration gradient as well as the cross flow pressure loss is small a number of Filtration Units may be placed in series and or in parallel to increase efficient filtration area.

The open structure of the element and a non-impeding, equal and tight distribution of the intakes and filter plates secure a high packing density and a low dead volume per square meter of membrane as well as very easy drain ability, thereby reducing product loss at cleaning.

The filter plates are sized according to need for filtration area and are typically from 10 by 10 cm of filter area up to 50 by 100 cm filter area, the typical size for industrial applications being 20 by 20 CM up to 30 by 100 cm.

The filter plates are stacked and fused together from a few, to many dozens of plates in one fused Filtration Unit, and for use in cross flow filtration typically so many that they form a square like unit seen from the media inlet and exit side. The Filtration Unit is then for cross flow placed in a tight fitting square pressure withstanding flow channel where one, or more elements in series or parallel are flushed over with media to be filtered and the Permeate is lead out of the side of the flow channel through connections to the permeate exits from the Filtration Unit(s).

The fused plates each form a pressure vessel besides the perforated area, so that when a back flow and pressure is applied from the exit a back flushing of the perforations can take place there by cleaning the active filter area—the slits or holes or the attached membrane or fine filter.

The rigid fused structure allows for the Filtration Unit to be exposed to vibration or a mechanical movement by actuation means, cause the Filtration Unit to be moved in a plane in parallel to the filter plates during operation, given flexible connections to the Filtration Unit. This movement of the filter surface in relation to the flow of media to be filtered, can with little use of energy, keep the filter surface clean and secure lower the concentration gradient of media close to the filter surface, thereby increasing flux of permeate per square meter filter area and keep the filter operational for longer time.

The fused Filtration Units can be handled as individual but complete elements by itself or together with flow channel, whereby simple service and handling is achieved and complex assembly of lots of small parts is avoided. Given the rectangular design, the filtration unit may be built into a suitably designed, pressure withstanding cross flow channel with sealed connections for permeate from the filtration unit to outside the channel, and suitable larger connections for media to be filtered to enter and exit the channel, herby enabling simple prevention of leakage issues.

The fused Filtration Unit with sufficient bonding points secures a rigid open structure of stacked filtration plates, and the rigid and open structure makes it possible to look in on the filter area, given that a look through glass is placed near the side of the Filtration Unit. This possibility of inspection allows for visual inspection of filtration process as well as for a full and thorough inspection of Filtration Unit after cleaning.

The Filtration Unit has as a result of the geometry and open structure a very high yield of flux of permeate through the filter area per square meter and, a relatively low energy consumption, when being used in cross flow operation, due to the pressure loss predominately only over the filter area.

Materials used for the Filtration Unit are typically polymeric or co-polymeric thermoplastics or any other suitable material that can withstand the media to be filtered, the temperature span needed, typically 5-75 degree Celsius (° C.) as well as the medias used for cleaning the Filtration Unit. Also the choice of material must foresee thermal expansion and rigidity of the unit. Preferred execution is filtration plates in molded plastic such as Polypropylene and with a polymeric membrane used as fine filter, both materials readily accessible in food grade versions on the market. Other executions can be as sintered parts or 3 D printed versions in various materials.

Fusing of the Filtration Unit parts into one unit including half plate to half plate fusing, fine filter to filter plate fusing and filter plate to stack fusing may be by laser welding, direct or indirect heat welding, ultrasonic welding, use of glue or solvents or mechanically bonding with mechanical elements or connections designed into the parts or combination there off. In the preferred execution plastic parts are welded together through heat applied melting of very specific areas of the designed parts, said filter plate parts being molded by injection molding of polymer thermoplastic.

### DESCRIPTION OF THE DRAWINGS

Other features and advantages of the invention is disclosed in the following description, with reference to the accompanying drawings wherein

FIG. 1 is a perspective view of a filter plate assembly,

FIG. 2 is a perspective view of a filter plate assembly,

FIG. 3 is an exploded perspective view of filter plates,

FIG. 4 shows cross-sectional views perpendicular to the longitudinal extension of the filter plates,

FIG. 5 is a side view and a perspective view of a filter plate assembly,

FIG. 6 is a perspective view of a filter plate assembly comprising a housing.

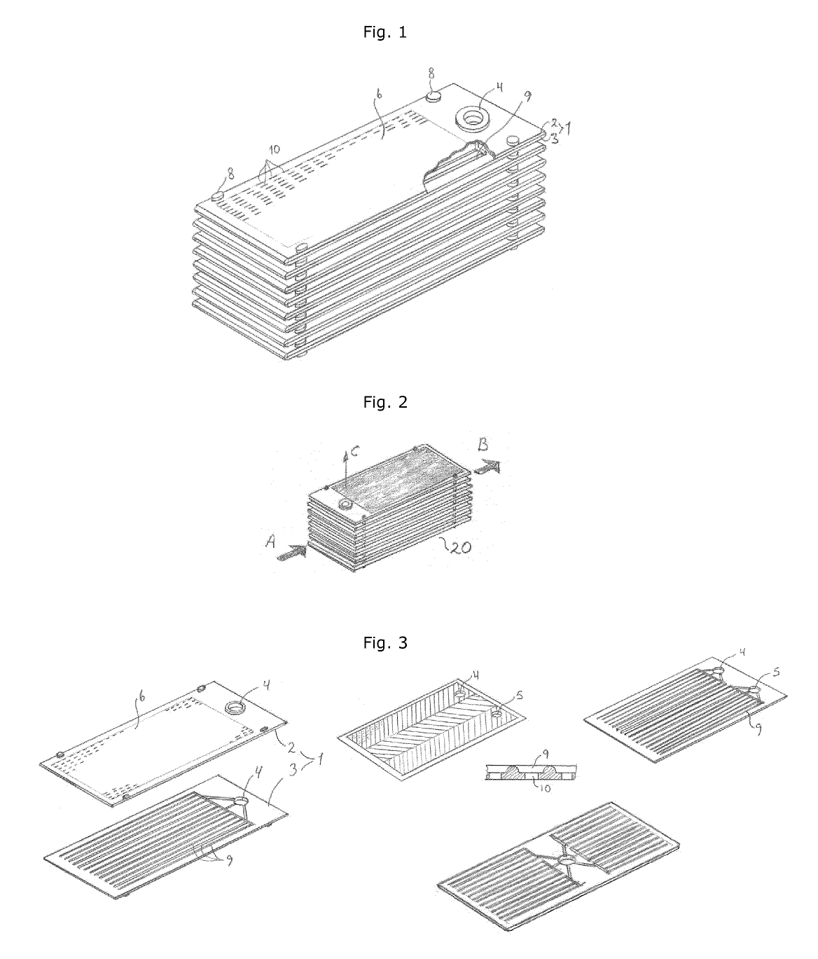

FIG. 1 illustrates one embodiment of the Filtration Unit formed by a fused stack of filter plates (1). In the illustrated embodiment, the permeate exit(4) of the Filtration Unit is at the end of the filtration area (6) and the filtration area is shown without a fine filtering element covering the numerous slit shaped perforations (10). As indicated a number of channels (9) connect to the permeate exit inside the filter plate and the perforations lead to these channels. The permeate exit from the unit can be sealed off at one side of the stack, depending on need for exit area. The slit or gap between filter plates, form the free entry area for media to be filtered.

FIG. 2 shows the flows of filtrate/retentate (A, B) and permeate (C). Retentate is the term used for media to be filtered, this can be in form of a liquid stream entering (A) and exiting (B) the filter area in the Filtration Unit in a continuously flowing stream when Filtration Unit is used in a cross flow mode.

FIG. 3 illustrates two half filter plates (2, 3) in an exploded view, showing the inside channels (9) of a filter plate connecting the inside permeate channels to the filter plate exits (4) and also shown are variations in layout of inside channels. The channels (9) may be joined in a manifold like channel before connecting to the larger exit holes (4, 5) or be formed as an open grid like channel formed by the two half plates where these meet. The exit hole or holes can be placed as convenient, for example in opposite corners or side by side, considering short and efficient drainage channels (9) for the permeate.

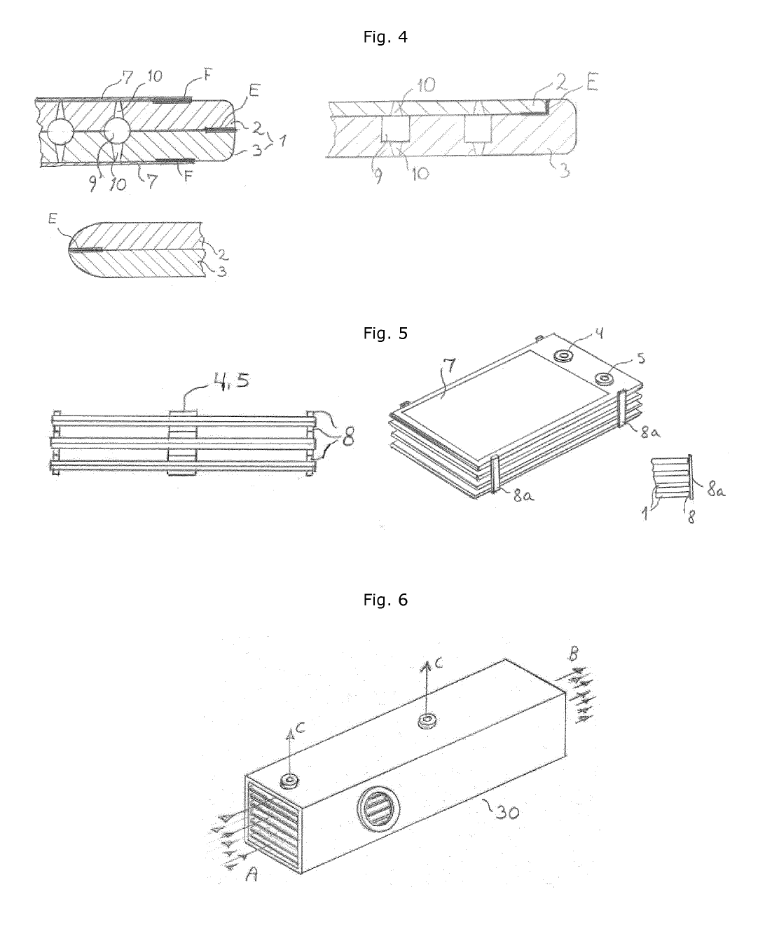

FIG. 4 illustrates details of a filter plate with example of the conical perforation (10) of the filter plates leading to permeate channels (9) in the filter plate and (E) illustrates fusing area of half filter plates (2, 3) and (F) fusing areas of an additional filter sheet (7), such as a fine filter cloth or organic filter membrane on both side to filter plate as well as example of pressure loss reducing edge of filter plate. Also shown are an example of a filter plate made up by two not identical half filter plates, where the channels are predominantly formed in one half.

The fusing (E) of the two half plats must secure a complete sealing of the inside of the fused filter plates all along the edge, so that filtrate only enters the permeate side at designated filtration area. To ensure rigid filter plates, the filter plates may be fused at various points within plate area, when two half filter plates (2, 3) are fused into one filter plate (1).

The edges of the filter plates (1) are streamlined to reduce resistance.

The fine filter cloth adding an additional filtration of a filter plate.

The fusing (F) of the fine filter, when this is relevant for the application of the Filtration Unit, on the two sides of the filter plats, must likewise secure a complete sealing of the inside of the fused filter plates all along the edge, so that filtrate only enters the permeate side at designated filtration area. To ensure rigid fixation of the fine filter to the filter plates, the fine filter may be fused at various points or lines within edge, as this will allow for trouble free back washing or back flushing of the fine filter.

Experiments have shown that a filter plate made by injection molding in plastic of 2 half plates of 2 mm plate thickness and with 2 mm permeate channels give a good rigid structure for 20 cm wide an 90 cm long filter plate and that slits of 0.1 mm by 5 mm that are spaced 5 mm sideways and longitudinal to permeate channel give good drain ability to open microfiltration organic membrane and good support to withstand a high trans membrane pressure of more than 10 bar when needed.

FIG. 5 illustrates two variations of a plural of filter plates fused into a stack, thereby forming a compounded Filtration Unit, and also showing a rigid structure achieved through the bonding points (8) and the fusing of permeate studs (4, 5). The fusing of the permeate studs must ensure a complete sealing of inside of the Filtration Unit, as filtrate must only enter the permeate side at the filtration areas. The number of and size of bonding points is adapted to the dimensions of the filtration plates and size of unit ensuring that sufficient structure is in place to secure a sufficiently rigid and strong Filtration Unit. Experiments have shown that 4 of ø5 mm bonding points in each corner will give a sufficient rigid support to a 20 cm by 20 cm filtration area, given that the filter plate is a 4 mm thick assembly of stiff polymeric plastic and that the permeate exits are rigidly fused and close to the filtration area. Similar strength is achieved when bonding points are in form of a Bonding Point Bar (8a) fused at various points to the side of the filter plates securing uniform spacing and rigid structure of the element.

FIG. 5 shows a filter plate assembly, wherein said filter plate assembly forms a rigid singular assembly through fusing of bonding points (8) and protruding exits (4,5).

The filter plates (1) comprise a first and a second rigid surface, said surfaces also called filter areas (6), which comprise perforations (10).

The additional filter sheet (7) is sufficiently bonded to said perforated surface (10) of the filter plates (1) with sufficient distance between filter plates (1) to allow for back flow of permeate through the filter membrane (7) without filter membranes colliding through ballooning of said filter membrane.

Hereby further improvement of filtration and increase in flux of permeate per filter area is possible through possible back flush or movement of the filter assembly.

The filter plate assembly forms an open rigid free flow structure allowing for mechanical actuation or vibration of the filter plate assembly parallel to the filter plates while the free access allow for movement of media to be filtered in relation to the filter plates (1).

FIG. 6 illustrates two Filtration Units in series placed in a pressure withstanding flow channel, where inspection of filter surface is possible through a look through glass, and where a cross flow stream can enter in one end and exit in the other end of the series mounted Filtration Units and where permeate can exit the side of the channel.

It goes without saying that different modifications may be made to the examples described, without departing from the scope and spirit of the invention.

Further embodiments are disclosed in the following.

A Filtration Unit in form of a compounded singular element, formed by a fused, rigid stack of internally channeled rectangular like, flat filter plates (1), each plate formed by fusing of two molded flat half filter plates (2, 3), fused together at least around edge in a way whereby sealing (E) is secured, the half plates being with substantially identical filtration areas (6) with a plural of perforation slits or holes (10), and with a thickness giving room for internal channels (9) where the half plates meet for unimpeded draining of permeated media entered through the perforations (10), said internal channels (9) leading to one or more filter plate exits (4, 5) with raised neck bracing perpendicular to filter plate surface, the filter plate exits forming exit channels for permeate from the compounded element forming the Filtration Unit as several filter plates (1) are fused together, in a way whereby sealing is secured, into a stack at the raised exits (4, 5) and at bonding points (8) securing that the filter plates are spaced and rigidly fixed at specific distance in the stack, offering slit like gaps at least at 2 sides for free access and exit flow of media to be filtered. The fused stack of filter plates forming the Filtration Unit shall form a sufficient rigid structure providing good dimensional stability under mechanical, thermal and chemical stress.

The filtration can be obtained through an added fine filter sheet (7) covering the filter area (6) and where the perforations (10) and the filter plats (1) offer drainage for the fine filter and so the Filtration Unit acts as collector and support for the fine filter, said fine filter being as example a fine mesh sheet or membrane suitable for Micro, Ultra, Nano filtration or Reverse Osmosis filtration, said fine filter fused to the filter plate fully covering the perforated filter area (6) in a way whereby sealing is secured at the edge.

The fine filter (7) is fused in numerous spots or lines to the filter plate (1) whereby a back flow of filtered permeate can wash the active filter area without damaging the fine filter, and whereby longer filtration time before need for cleaning can be achieved.

The Filtration Unit comprises a housing (30) having at least one see through part, such as a window, giving access to visual observation of filtration area (6) and all other parts and details (for example through look through glass close to Filtration Unit if this is placed in a channel) as well as good access for flow of cleaning media to all surfaces, this being possible through the rigid structure and free spacing between the stacked and fused filter plates.

The edges of the filter plates are formed with a hydro dynamically shaped gradient to minimize pressure loss of flow entering or exiting the free passage over filtration area through the slit like gaps between filter plates and where the flat surface of the filter area (6) is corrugated to increase turbulence of media to be filtered over filtration area.

The filter plates (1) are stacked and fused into a unit where the number of stacked filter plates typically compile to form a square size Filtration Unit seen from entry and exit side of flow direction, the opening and free passage for media to be filtered is between 1 and 6 mm between opposite arranged filter plates and where each filter plate is between 2 and 6 mm thick comprised by two half plates (3, 4) typically molded in plastics or other media withstanding and rigid material and with dimensions giving room for a filtration area from some 10's of square centimeter to some 10's of square decimeter and with internal channels or free area for permeated media up to half the thickness of the filter plate and with numerous conical filtration perforations as slits or holes connecting filter plate surface and the internal channels with perforation openings of 0.05 to 0.50 mm at the surface, said internal channels leading to filter plate exits (4, 5) of typically a diameter of 10 to 50 mm. It shall be noted that the overall design hereby gives possibility to have many square meters of filtration area in one compact Filtration Unit.

The half plates (2, 3) fusing into edge-wise sealed filter plates and the fusing of edge-wise sealed fine filter (7) onto filter plates (1) and the edge-wise sealed fusing of filter plate exit to filter plate exit (4, 5) or the fusing of bonding points (8), said fusing can be through direct or indirect or laser or ultrasonic or otherwise applied heat for re-melting material of said parts or for melting added material or for a media to dissolve material or to add glue or to add mechanical fixtures or combination of above to perform a weld or fused bond of the assemblies and subassemblies together forming the Filtration Unit

The filter plates (1) are positioned in parallel or in series in a suitable pressure withstanding flow channel, wherein the filter areas are flushed over by media to be filtered in a cross flow created by a fast moving flow, flowing through the Filtration Unit via the slit like gaps, and where the permeate exits the Filtration Unit exit (4, 5) out through the side of the pressure withstanding flow channel in suitably dimensioned and sealed permeate exit connections.

The rigid fused structure allows for the Filtration Unit by itself or when fixed in a flow channel, to be exposed to a mechanical movement parallel to the filter plates and hence filter surface and to the flow of media to be filtered, keeping the filter surface clean and secure lower the concentration gradient of media close to the filter surface, thereby increasing flux of permeate per square meter filter area and keep the filter operational for longer time.

All parts can be of food and pharmaceutical grade material with traceable origins, making the Filtration Unit suitable for human food consumables and the likes. The materials used are preferably of a plastic material that can be reused by re-melting or burned as a clean fossil-like fuel.

The parts of the unit are produced by 3 D printing or sintering of other means.

1. A filter plate assembly (20,1) configured for cross-flow filtration, said filter plate assembly comprises a plurality of plastic molded planar square or rectangular filter plates (1) and one or more permeate exits (4,5), said filter plates (1) comprises a first and a second rigid surface, said surfaces comprise perforations (10), said surfaces enclosing a volume, said volume constitute one or more permeate channels (9), whereby said perforations (10) are fluidly connected to said one or more permeate exit (4,5) through said permeate channels (9), characterized in that said filter plates comprises a protrusion, said protrusions of said plurality of filter plates combined forms said permeate exits (4,5) from the filter plate assembly.

2. A filter plate assembly (20,1) according to claim 1, wherein one or more of said filter plates (1) comprises two half filter plates (2,3), said half filter plates (2,3) are bonded together at the periphery of the filter plates.

3. A filter plate assembly (20,1) according to claim 2, wherein said half filter plates (2,3) being identical in shape.

4. A filter plate assembly (20,1) according to claim 1, wherein said one or more permeate exits (4,5) extends perpendicular to the plane defined by the extent of said filter plates (1).

5. A filter plate assembly (20,1) according to claim 1, wherein said filter plates (1) comprising an additional filter sheet (7) positioned and bonded adjacent to said perforated surface of said filter plates (1).

6. A filter plate assembly (20,1) according to claim 1, wherein said filter plate (10) comprises bonding points (8) for bonding two adjacent filter plates (1), said bonding points together with the protruding exits (4,5) defining the distance between two juxtaposed filter plates (1), and said filter plate assembly (20) forms a rigid singular assembly through fusing of said bonding points (8) and protruding exits (4,5).

7. A filter plate assembly according to claim 1, wherein said filter plate assembly (20) comprises actuation means for mechanical actuation such as movement or vibration of said filter plate assembly in a plane parallel to the extent of said filter plates (1).

8. A filter plate assembly (20) according to claim 1, wherein said filter plate assembly (20) comprises a plurality of filter plates (1) and a housing (30), said filter plates are situated parallel juxtaposed having the perforated surface facing the perforated surface of an adjacent filter plate, said housing encompassing said plurality of filter plates (1) forming a square or rectangular entry for a media (A) to be filtered and a retentate exit (B).
